(19) United States
(12) Patent Application Publication
(10) Pub. No.: US 2009/0210222 A1
(43) Pub. Date: Aug. 20, 2009

(54) Multi-Channel Hole-Filling For Audio Compression

(75) Inventors: Sanjeev Mehrotra, Kirkland, WA (US); Hui Gao, Redmond, WA (US); Kazuhito Kioshida, Redmond, WA (US); Chao He, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/032,119

(22) Filed: Feb. 15, 2008

(51) Int. Cl. G10L 19/00

(52) U.S. Cl. 704/230; 704/E19.01

(57) ABSTRACT

Multi-channel hole-filling for audio compression is disclosed. Channel dependency groups (CDGs) are explicitly extracted based on channel transform information. Holes are detected within each CDG for each bark, and a CDG hole is identified as requiring filling as a particular section of frequency bandwidth larger than a predetermined hole bandwidth threshold and with all zero-value coefficients in all channels after quantizing. Bark weights are adjusted by multiplying the original bark weights with one calculated scalar so as to remove each detected CDG hole.

### BACKGROUND

Spectral hole-filling is a known problem in the field of audio compression. A spectral “hole” in connection with audio compression refers to a frequency range in a frequency-domain spectrum representative of a particular portion of compressed audio, where such frequency range comprises all coefficients coded as zero. As may be appreciated, such a phenomenon often occurs when a large compression ratio is desired for such audio compression. As it turns out, human hearing is sensitive to one or more of such holes in such a spectrum if such holes are larger than a maximum hole bandwidth, and accordingly such holes greater than such minimum bandwidth should be avoided when performing encoding compression of an audio signal.

In pertinent part, audio compression is typically performed in the following manner. Preliminarily, an audio signal is supplied, where the audio signal has one or more channels (left, right, front, back right, etc.) and each channel of the audio signal is sampled in the time domain at some predetermined rate, say about 44.1 kHz, where each sample has some predetermined bit length, say 16 or 24 bits. As should be understood, for just a 2 channel audio signal that is 3 minutes long and based on 16 bit samples, the size of the samples collected from such an audio signal is 2*180*44100*16 bits, which is 254016000 bits or 31752000 bytes or about 30 megabytes, which is a relatively large amount of data. Accordingly, the sampled audio signal may be compressed to a more manageable size.

In one usual audio compression technique, the sampled audio signal is compressed by first converting same to a frequency-based representation, according to a transforming algorithm such as the modified discrete cosine transform (MDCT). As known, MDCT is a Fourier-related transform that is performed on consecutive blocks of the sampled audio signal, where subsequent blocks are overlapped so that the last half of one block coincides with the first half of the next block. Such overlapping helps to avoid artifacts stemming from block boundaries.

At any rate, the output of such a transform is a representation of each block of the sample audio signal in the frequency domain, and in particular a number of digital spectral coefficients representing amplitudes at particular frequencies within the frequency domain. Such coefficients are particularly useful during audio compression because many compression techniques are frequency-based and take advantage of how the human ear hears different audio frequencies. For example, inasmuch as such human ear is less sensitive to higher frequencies, such higher frequencies can be weighted less during compression, thus saving bit rate. Likewise, inasmuch as a strong tone at a particular frequency tends to mask out other tones at adjacent frequencies in the human ear, such tones at the adjacent frequencies can be weighted less during compression, again thus saving bit rate.

One particular aspect of such compression is that quantizing is performed on the digital spectral coefficients. As known, such quantizing comprises removing a predetermined number of least-significant bits from each coefficient. In particular, the coefficients are organized according to predetermined frequency bands or ‘barks’, and each bark has a weight defined therefor, where the bark weight determines how many of the least-significant bits of each coefficient within the bark are removed. For example, one bark may include all coefficients within the frequency range of 100 to 250 Hz, and the weight for such bark may determine that the three least significant bits of each coefficient in such bark are removed. In such a case, it may be that a coefficient with value 1101 1000 1001 0101 is quantized to 1101 1000 1001 0.

Note, however, that quantizing a non-zero value coefficient may render the quantized coefficient to have a zero value. For example, a coefficient with value 0000 0000 0011 0111 after being quantized to remove the 7 least-significant bits is 0000 0000 0. As should be understood, then, quantizing based on a relatively smaller bark weight may save more space but may result in frequency ranges of zero value coefficients (i.e., holes) that are relatively large, perhaps even larger than a maximum hole bandwidth. In contrast, quantizing based on a relatively larger bark weight would save less space but would result in holes that are relatively smaller. Accordingly, the challenge is to ‘fill’ each hole by setting the bark weight for each bark large enough so as to save as much space as is practicable while at the same time small enough to avoid holes that are too large.

One known hole-filling approach works by forcing the quantizing encoder to generate at least one coefficient within any blocks of continuous holes which reach a size of pre-determined threshold. Such an approach is effective and efficient in reducing the size of holes in the frequency spectrum, but is limited by assuming a maximum of two input channels (either mono or stereo audio inputs). The two channels are scanned individually while accommodating some channel dependency information. As may be appreciated, such an approach lacks the flexibility to handle multi-channel inputs. Furthermore, when updating the quantizing encoder to fill in the holes, the bark weights of the two channels are assigned the same value, which by definition does not allow different bark weights for the same bark in different channels. This approach not only limits the quality of the encoder (i.e., quantizer) in the two-channel case, but also is difficult to extend to the multi-channel case.

Accordingly, a need exists for a hole-filling approach that addresses such limitations of the known two-channel hole-filling algorithm. In particular, a need exists for a hole-filling approach that includes a multi-channel hole-filling algorithm, and specifically a hole-filling approach that fills holes larger than a predetermined maximum hole bandwidth.

### SUMMARY

The above-described approach may be expanded into the multi-channel case by explicitly extracting channel dependency groups based on channel transform information. Holes may be detected within each channel group for each bark. Then, differences in channel groupings may be systematically handled across bark boundaries by calculating the appropriate starting points. In such a new approach, bark weights are adjusted by multiplying the original bark weights for a particular bark with one calculated scalar. Such an approach maintains the ratio of bark weights for the particular bark across channels in the dependency group, which yield better encoding quality and is elegant in design.

In the present invention, then, hole-filling is performed in connection with audio compression of a multi-channel audio signal. A set of coefficients in a frequency spectrum is derived for each channel based on a frequency transform applied to the channel, where the frequency spectrum is divided into contiguous sections (‘barks’), and for each channel each set of coefficients of the channel within each bark is quantized according to a bark weight derived for the bark and channel. Such quantizing creates one or more frequency ranges of such coefficients that are reduced to zero values (‘holes’) in one or more particular channels. To fill at least one hole with at least one non-zero value coefficient, each channel for a particular bark is assigned to one of one or more channel dependency groups (CDG), where each CDG represents a grouping of channels based on a perceived similarity therebetween. For each CDG of the particular bark, every channel in the CDG is examined for holes, and a CDG hole is identified as requiring filling as a particular section of frequency bandwidth larger than a predetermined hole bandwidth threshold and with all zero-value coefficients in all channels after quantizing.

Thereafter, for each CDG of the particular bark, a maximum value is recorded for each full length of the hole bandwidth threshold in the identified CDG hole, where the maximum value is of the coefficients in the length of all channels prior to quantizing, and a minimum value of the recorded maximum values is determined. With such minimum value, the bark weight for each channel of the bark is proportionally scaled according to a common scalar so as to achieve a non-zero value for the coefficient having such minimum value, and each channel is re-quantized according to the scaled bark weight thereof. Thus, the coefficient having each recorded maximum value as re-quantized should have a non-zero value.

### BRIEF DESCRIPTION OF THE DRAWINGS

FIG. 1 is a block diagram of an example computing environment in which example embodiments and aspects of the present invention may be implemented.

FIG. 2 is a frequency domain diagram showing multiple channels of an audio signal extracted into Channel Dependency Groups in accordance with embodiments of the present invention.

FIG. 3 is a frequency domain diagram showing a bark of a Channel Dependency Group of FIG. 2, where the bark exhibits a spectral hole requiring filling in accordance with embodiments of the present invention.

FIG. 4 is a frequency domain diagram showing the bark of FIG. 3, where the spectral hole has been filled in accordance with embodiments of the present invention.

FIG. 5 is pseudo-code representing an algorithm employed to fill the spectral hole of FIG. 3, where the result of applying such algorithm is shown in FIG. 4, in accordance with embodiments of the present invention.

### DETAILED DESCRIPTION

As was set forth above, a common problem in audio compression, which occurs particularly at lower bit rates, is that all coefficients in certain frequency range may become zero after quantization. Hence, no information can be coded for such zero value coefficients, which will consequentially form “holes” in the reconstructed spectrum during decoding. As human ears are highly sensitive to such holes if larger than a hole bandwidth threshold, it is important to design an algorithm to ‘fill’ such holes with at least one non-zero value coefficient during encoding/quantizing.

In the prior art, a two-channel hole-filling algorithm was employed for the case of mono or stereo inputs. Such prior art algorithm operates on each individual channel. For a mono channel, the algorithm scans the spectrum and detects each hole as a continuous block of coefficients which are originally non-zero but become zero after quantization at the current quantization step size. If the bandwidth of such a hole exceeds a hole bandwidth threshold, the prior art algorithm forces the encoder to output at least one non-zero value coefficient within the block.

In particular, in such prior art algorithm, a preliminary quantization is performed on a set of coefficients based on a preliminary set of bark weights to produce a spectrum of quantized coefficients. Thereafter, the quantized coefficients are scanned from the beginning of the spectrum (i.e., 0 Hz) upward until a coded non-zero coefficient is found or until at least “T” Hz of the spectrum have been scanned and found to form a spectral hole as a continuous block of zero value quantized coefficients (i.e., quantized coefficients which are originally non-zero but have been quantized to zero). If the scan stops prior to scanning T Hz because a coded non-zero coefficient is found, then repeat the scan from the current location. If the scan has stopped because at least T Hz of the spectrum have been scanned and found to form a hole, then store the location and value of the largest coefficient (prior to quantizing) within the hole.

Such coefficient as should be appreciated is the maximum original coefficient in the found hole. The encoder then adjusts the quantization step size for the maximum original coefficient of the found hole by adjusting the bark weight of the corresponding bark which contains such maximum original coefficient to ensure a non-zero coefficient at that location after re-quantization. Then the scan can resume from the last coded position until the whole spectrum is scanned. The adjustment is done for each bark by tweaking the bark weights, which are involved in generating the coefficients. The minimum value of those must-be-coded coefficients is retained for each bark, which will be used to calculate the new bark weights to ensure that all of them are coded.

For stereo (i.e., two) channels, the prior algorithm simply checks both channels for holes when a channel transform is enabled and is non-identity. As should be understood, the two coefficients (one for each channel) are be combined into one by the channel transform, and such combined coefficient is used to record the maximum in the block. Such a channel transform is generally known and therefore need not be set forth herein in any detail. Additionally, the adjusted bark weight for the two coefficients is computed based on the combined coefficient. Hence, such adjusted bark weight is the same for both channels.

In the present invention, then, and generally, the above-described two-channel hole-filling algorithm is extended to the general case of multiple channels.

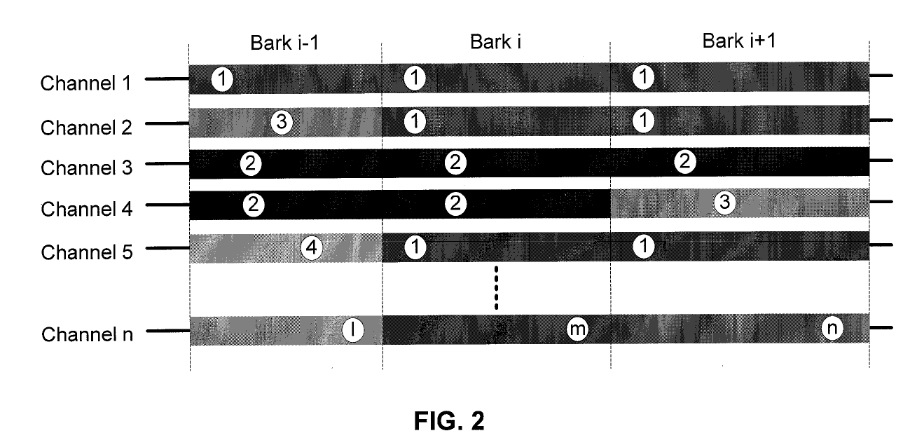

In one embodiment of the present invention, then, and turning now to FIG. 2, channel dependency groups (CDG) are explicitly identified for each bark based on the original channel grouping and channel transform information. Such CDGs for each bark may be identified in any appropriate manner, and are generally known. Generally, each CDG represents a grouping of channels based on a perceived similarity therebetween. Also, applying channel transforms to such CDGs is generally known and may be any appropriate channel transforms. As seen in FIG. 2, such CDGs may change from bark to bark. That is, since there may be several channel groupings in one bark and each channel transform can be turned on or off, different configurations of channel dependency groups may be formed in different barks. For example, in FIG. 2, for bark (i), channels 1, 2, and 5 form CDG 1 and channels 3 and 4 form CDG 2, while for bark (i+1), channels 3 and 4 are no longer in a single CDG.

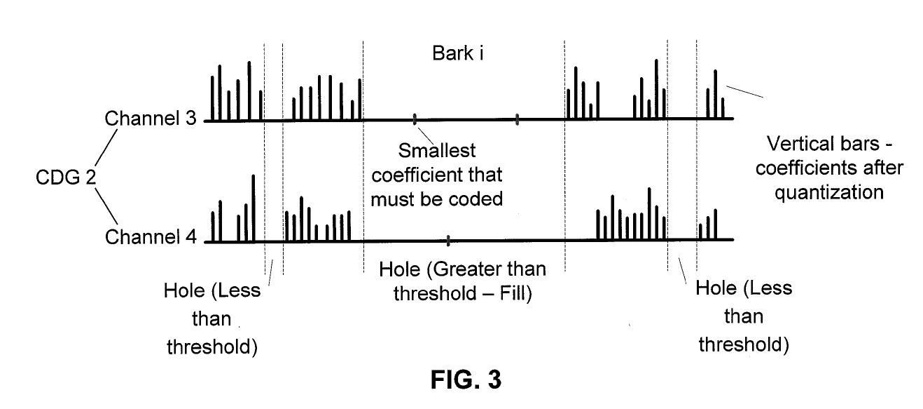

Significantly, in the present invention, the hole-filling algorithm is operated independently on each CDG. As shown in FIG. 3, then, CDG 2 of bark (i) of FIG. 2 is operated on, where the original coefficients are assumed to be non-zero. In FIG. 3, the vertical bars refer to the coefficients after quantization. In particular, such algorithm of the present invention identifies holes by examining all channels in each CDG. As seen in FIG. 3, for example, three holes have been delineated by vertical dashed lines, and include only those blocks of bandwidths with all zero-value coefficients in all channels of the CDG. That is, for any particular section of frequency bandwidth, only when the coefficients thereof in all the channels are coded zero after quantization and yet there is at least one non-zero original coefficient, the section is considered as a hole.

Thus, and as shown in FIG. 3, the gap in channel 3 in the section between the middle and right holes is not in fact a hole because channel 4 does not likewise exhibit such a gap. Thereafter, the similar searching logic as used in the two-channel case can be applied to detect the continuous blocks of zero-value coefficients that form holes. Once a pre-determined hole bandwidth threshold value such as for example 70 Hz is met as a threshold, the algorithm of the present invention simply records the maximum of the original coefficients of all channels in the CDG, which is used in a new method of bark weights adjustment as set forth below. As should be understood, then, the algorithm of the present invention is different from that of the prior art algorithm, in that the algorithm of the present invention does not take the combined coefficients of both channels, as is the case with the prior art two-channel algorithm.

In the present invention, to accommodate the new characteristics of different CDGs in adjacent barks, the last-coded coefficients are adjusted at the bark boundary therebetween. All channels in a current CDG receive the same last-coded coefficients at the end of bark (i). At the beginning of bark (i+1), a new last-coded coefficient is generated based on all channels in the new CDG by taking the maximum of all last-coded coefficients or by directly using the right-most element.

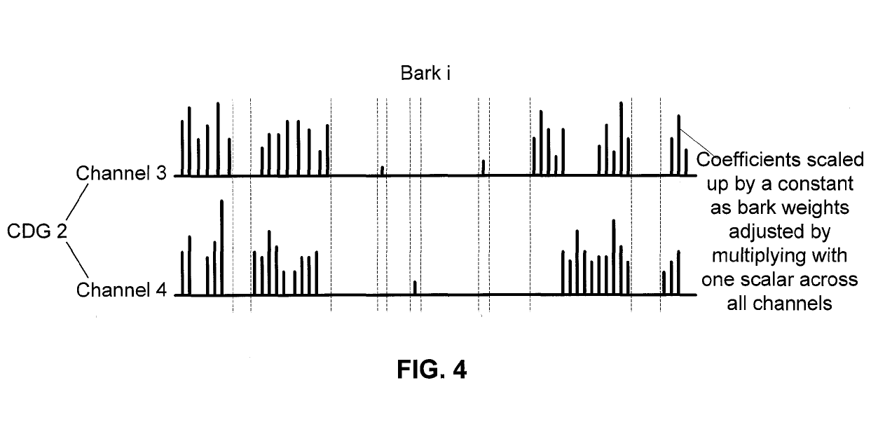

Also in the present invention, when the scan of holes is performed, the minimum value of those must-be-coded coefficients is extracted for each bark. As is shown in FIG. 3, the hole at issue is the middle hole, and the must-be-coded coefficient with such minimum value is the coefficient to the left in channel 3. Note here that such coefficient is shown as a hash in the spectrum and that another hash is shown in each of channels 3 and 4. As seen in FIG. 4, such hashes signify non-zero value coded coefficients that result in the hole in response to the algorithm of the present invention.

Further in the present invention, a new bark weights adjusting scheme is employed, which proportionally scales each bark weight with one scalar. The scalar is calculated such that the encoder can produce a non-zero coefficient for the minimum coefficient. Therefore, all those must-be-coded coefficients in the bark will be guaranteed to be coded non-zero, which effectively eliminates large holes in the bark. Note that as between FIGS. 3 and 4, the coefficients are scaled up by a constant as the bark weights are adjusted by the scalar as applied across all channels. Those must-be-coded coefficients are now present in the quantized spectrum and effectively eliminate the (middle) hole which was larger than the predetermined hole bandwidth threshold and is now broken into a series of holes each of which is smaller than such hole bandwidth threshold.

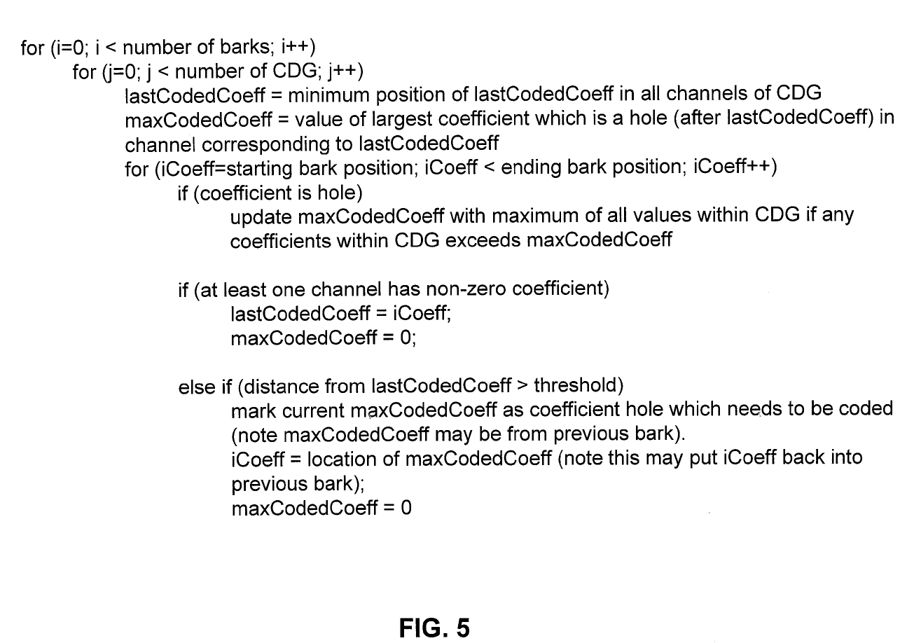

Turning now to FIG. 5, the algorithm of the present invention is set forth as pseudo-code which should be understood by the relevant public, and encompasses both finding holes and locating coefficients in holes that must be coded. Here, a coefficient refers to a channel transformed and bark and channel weighted coefficient which is to be quantized by a quantization step size. The quantization is such that all coefficient values less than half the step size are quantized to zero. A hole is defined to be a coefficient which has at least one non-zero value in any of the channels within a CDG, but is coded as a zero in all channels within such CDG. Note that each bark has its own CDGs, so when the algorithm goes back into the previous bark, it assumes the previous bark has the same CDG settings, which may not yield the optimal solution. However, this treatment completely satisfies the hole-filling rules in not allowing any holes larger than the specified threshold. It may only code a few more coefficients than the amount absolutely needed in small transition regions near the bark boundaries.

The algorithm as shown in FIG. 4 is annotated as follows:
for (i=0; i<number of barks; i++)
   For each sequential bark, from 0 Hz upward,
for (j=0; j<number of CDG; j++)
   and for each CDG in the bark:

lastCodedCoeff = minimum position of lastCodedCoeff in all channels of
CDG

The ‘last coded coefficient’ is defined to be the minimum position of the last coded coefficient across all channels of the CDG.

maxCodedCoeff = value of largest coefficient which is a hole (after
lastCodedCoeff) in channel corresponding to lastCodedCoeff

The ‘maximum coded coefficient’ is defined to be the value of the largest coefficient prior to quantizing which is a hole after quantizing (i.e., initially quantized to a zero value) in the channel from which lastCodedCoeff was found.

for (iCoeff=starting bark position, iCoeff < ending bark position;
iCoeff++)

For each bark position within the bark, from the boundary with the previous bark and upward:
if (coefficient is hole)
   If the coefficient at the bark position in each channel of the CDG is a hole,

update maxCodedCoeff with maximum of all values within
CDG if any coefficients within CDG exceeds
maxCodedCoeff

update maxCodedCoeff to be the maximum of all values of coefficients at the bark position within the CDG, but only if any of such values exceeds what was previously stored as maxCodedCoeff, and if updated note position and channel of maxCodedCoeff.
if (at least one channel has non-zero coefficient)
   If the coefficient at the bark position in any channel of the CDG is not a hole (i.e., the ‘CDG hole’ has been found to end),
lastCodedCoeff=iCoeff;
   update lastCodedCoeff to be the current bark position so as to note the beginning of a potential new CDG hole,
maxCodedCoeff=0;
   and reset maxCodedCoeff to zero.
else if (distance from lastCodedCoeff>threshold)
   However, if the coefficient at the bark position in any channel of the CDG is in fact a hole AND if the distance from lastCodedCoeff is greater than a threshold (i.e., a predetermined hole bandwidth threshold, which may be about 70 Hz or so or perhaps a greater or lesser value),

mark current maxCodedCoeff as coefficient hole which
needs to be coded (note maxCodedCoeff may be from
previous bark)

maxCodedCoeff is noted for coding,

iCoeff = location of maxCodedCoeff (note this may put
iCoeff back into previous bark);

iCoeff is noted as the bark position of the coefficient from which maxCodedCoeff was found,
maxCodedCoeff=0;
   and reset maxCodedCoeff to zero.

A CDG hole larger than the hole bandwidth threshold may measure at least N full hole bandwidth thresholds, where N is a whole number greater than or equal to 1. For example, for a CDG hole that is 2.6 full hole bandwidth thresholds wide, N may be 2. It should be understood, however, that, in practice, because the max coefficients are chosen within each threshold, its position is not guaranteed to be close to the threshold at all. For example, with a threshold of 70 Hz and hole width of 200 Hz, the first max coefficient may be chosen at 30 Hz. Starting from there, another 70 Hz (e.g., from 30 Hz-100 Hz) may be scanned. The second max coefficient may be found at 60 Hz, for example, and so on. Eventually, fills may be found at 30, 60, 90, 120, 150, and 180 Hz, for example. Thus, there may be six fills instead of the theoretical two fills.

Thus, for each of the N hole bandwidth thresholds within the CDG hole, then, a particular coefficient of a particular channel may be found that has a maximum value prior to quantizing, where both the position and the value thereof prior to quantizing is noted so as to ‘code’ (i.e., mark for non-zero quantizing) such found coefficient. Accordingly, once the bark positions that are to be coded to fill holes have been noted, coding such bark positions is a relatively simple matter, as should be understood, and includes adjusting the corresponding bark weights by an appropriate amount to achieve non-zero values at such bark positions in appropriate ones of the channels within the CDG. Note here that all bark weights for each bark and for each CDG (one bark weight for each channel of the CDG) should be adjusted by a single scalar for the bark and CDG (by a scale factor of (quantStep/2)/minCodedCoeff or greater), although such bark weights may alternately be adjusted individually (again by a scale factor of (quantStep/2)/minCodedCoeff or greater). In either case, minCodedCoeff is the minimum value of the maximum values prior to quantizing of the marked coefficients for the CDG and bark.

As may be appreciated, adjusting by a single scalar for all channels within a CDG is performed since bark weighting is being applied prior to channel transforming. In contrast, individual bark weighting would be needed if the bark weighting was being applied after such channel transforming. In the former case, and as is known, the coded channel coefficient is given by yQ_i=round(sum_j(x_j*W_j*a_ij)/Q), where a_ij is the channel transform coefficients, W_j is the bark weights, and x_j is the original (prior to channel transform) coefficients, the sum being over all j to give a bark weighted channel transformed coefficient i, which is quantized with step size of Q to give yQ_i. In order to make sure yQ_i is non-zero, all bark weights W_j can be adjusted by a single scalar. In the latter case, and as is also known, yQ_i=round(sum_j(x_j*a_ij)*W_i/Q). Here, to make sure yQ_i is non-zero, we can simply adjust W_i individually.

### Exemplary Computing Arrangement

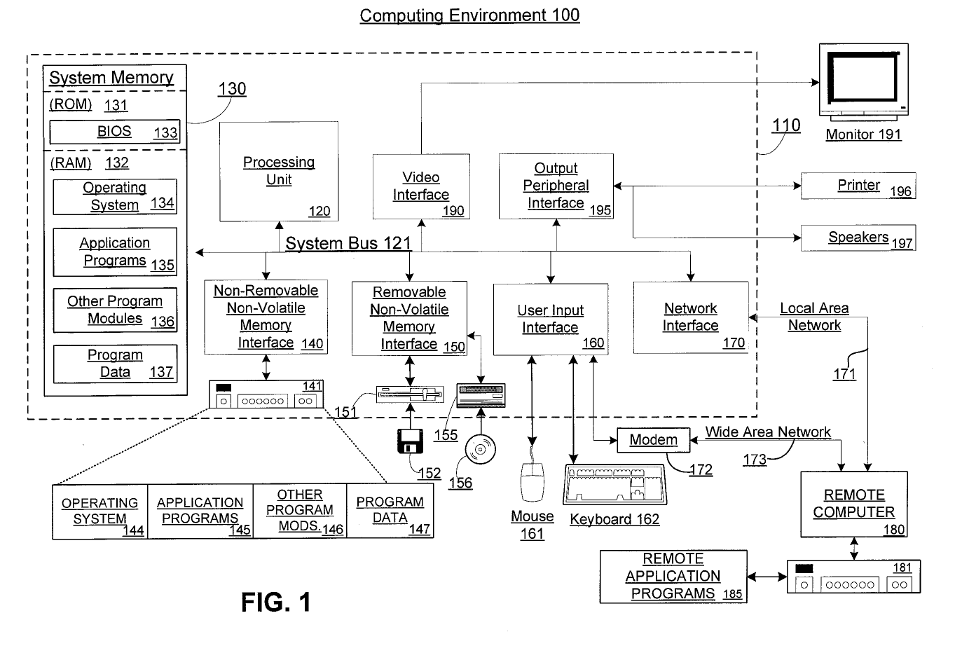

FIG. 1 shows an exemplary computing environment in which example embodiments and aspects may be implemented. The computing system environment 100 is only one example of a suitable computing environment and is not intended to suggest any limitation as to the scope of use or functionality. Neither should the computing environment 100 be interpreted as having any dependency or requirement relating to any one or combination of components illustrated in the exemplary operating environment 100.

Numerous other general purpose or special purpose computing system environments or configurations may be used. Examples of well known computing systems, environments, and/or configurations that may be suitable for use include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 1, an exemplary system includes a general purpose computing device in the form of a computer 110. Components of computer 110 may include, but are not limited to, a processing unit 120, a system memory 130, and a system bus 121 that couples various system components including the system memory to the processing unit 120. The processing unit 120 may represent multiple logical processing units such as those supported on a multi-threaded processor. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). The system bus 121 may also be implemented as a point-to-point connection, switching fabric, or the like, among the communicating devices.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of hole-filling performed in connection with audio compression of a multi-channel audio signal, wherein a set of coefficients in a frequency spectrum is derived for each channel based on a frequency transform applied to the channel, the frequency spectrum being divided into a plurality of contiguous sections (‘barks’), and wherein for each channel each set of coefficients of the channel within each bark is quantized according to a bark weight derived for the bark and channel, such quantizing creating one or more frequency ranges of such coefficients that are reduced to zero values (‘holes’) in one or more particular channels, the method for filling at least one hole with at least one non-zero value coefficient and comprising:
assigning, for a particular bark, each channel to one of one or more channel dependency groups (CDG), each CDG representing a grouping of channels based on a perceived similarity therebetween; and
for each CDG of the particular bark, examining every channel in the CDG for holes, and identifying a CDG hole requiring filling as a particular section of frequency bandwidth larger than a predetermined hole bandwidth threshold and with all zero-value coefficients in all channels after quantizing.

2. The method of claim 1 further comprising for each CDG of the particular bark:
recording, for each full length of the hole bandwidth threshold in the identified CDG hole, a maximum value of the coefficients of all channels prior to quantizing;
determining a minimum value of the recorded maximum values;
proportionally scaling the bark weight for each channel of the bark according to a common scalar so as to achieve a non-zero value for the coefficient having such minimum value; and
re-quantizing each channel according to the scaled bark weight thereof, whereby the coefficient having each recorded maximum value as re-quantized should have a non-zero value.

3. The method of claim 2 wherein the scalar is calculated such that the encoder can produce a non-zero value for the coefficient having the minimum value.

4. The method of claim 2 wherein the scalar is at least a quantization step size/2/the minimum value.

5. The method of claim 1 wherein the CDGs change from bark to bark.

6. The method of claim 1 comprising identifying the CDG hole as a particular section of frequency bandwidth larger than a predetermined hole bandwidth threshold and with all zero-value coefficients in all channels after quantizing, where at least one coefficient of the CDG hole is non-zero prior to quantizing.

7. The method of claim 1 wherein the hole bandwidth threshold is about 70 Hz.

8. The method of claim 1 comprising performing an algorithm with regard to each bark and each CDG thereof, the algorithm comprising:
```
for (i=0; i < number of barks; i++)
  for (j=0; j < number of CDG; j++)
    lastCodedCoeff = minimum position of lastCodedCoeff in all
    channels of CDG
    maxCodedCoeff = value of largest coefficient which is a hole (after
    lastCodedCoeff) in channel corresponding to lastCodedCoeff
    for (iCoeff=starting bark position; iCoeff < ending bark position;
    iCoeff++)
      if (coefficient is hole)
        update maxCodedCoeff with maximum of all values within
        CDG if any coefficients within CDG exceeds
        maxCodedCoeff
      if (at least one channel has non-zero coefficient)
        lastCodedCoeff = iCoeff;
        maxCodedCoeff = 0;
        mark current maxCodedCoeff as coefficient hole which
        needs to be coded (note maxCodedCoeff may be from
        previous bark)
        iCoeff = location of maxCodedCoeff (note this may put
        iCoeff back into previous bark);
        maxCodedCoeff = 0;
```

9. The method of claim 1 comprising performing an algorithm with regard to each bark and each CDG thereof, the algorithm as annotated comprising:
for (i=0; i<number of barks; i++)
For each sequential bark, from 0 Hz upward,
for (j=0; j<number of CDG; j++)
and for each CDG in the bark:
lastCodedCoeff = minimum position of lastCodedCoeff in all channels of
CDG
The ‘last coded coefficient’ is defined to be the minimum position of the last coded coefficient across all channels of the CDG.
maxCodedCoeff = value of largest coefficient which is a hole (after
lastCodedCoeff) in channel corresponding to lastCodedCoeff
The ‘maximum coded coefficient’ is defined to be the value of the largest coefficient prior to quantizing which is a hole after quantizing (i.e., initially quantized to a zero value) in the channel from which lastCodedCoeff was found.
for (iCoeff=starting bark position; iCoeff < ending bark position;
iCoeff++)
For each bark position within the bark, from the boundary with the previous bark and upward:
if (coefficient is hole)
If the coefficient at the bark position in each channel of the CDG is a hole,
update maxCodedCoeff with maximum of all values within
CDG if any coefficients within CDG exceeds
maxCodedCoeff
update maxCodedCoeff to be the maximum of all values of coefficients at the bark position within the CDG, but only if any of such values exceeds what was previously stored as maxCodedCoeff, and if updated note position and channel of maxCodedCoeff.
if (at least one channel has non-zero coefficient)
If the coefficient at the bark position in any channel of the CDG is not a hole (i.e., the ‘CDG hole’ has been found to end),
lastCodedCoeff=iCoeff;
update lastCodedCoeff to be the current bark position so as to note the beginning of a potential new CDG hole,
maxCodedCoeff=0;
and reset maxCodedCoeff to zero.
else if (distance from lastCodedCoeff>threshold)
However, if the coefficient at the bark position in any channel of the CDG is in fact a hole AND if the distance from lastCodedCoeff is greater than a threshold (i.e., a predetermined hole bandwidth threshold),
mark current maxCodedCoeff as coefficient hole which
needs to be coded (note maxCodedCoeff may be from
previous bark)
maxCodedCoeff is noted for coding,
iCoeff = location of maxCodedCoeff (note this may put
iCoeff back into previous bark);
iCoeff is noted as the bark position of the coefficient from which maxCodedCoeff was found,
maxCodedCoeff=0;
and reset maxCodedCoeff to zero.

10. The method of claim 1 wherein the hole bandwidth threshold is modified based upon a target bit rate and frequency location.

11. A computer-readable medium having stored thereon computer-executable instructions for performing a method of hole-filling performed in connection with audio compression of a multi-channel audio signal, wherein a set of coefficients in a frequency spectrum is derived for each channel based on a frequency transform applied to the channel, the frequency spectrum being divided into a plurality of contiguous sections (‘barks’), and wherein for each channel each set of coefficients of the channel within each bark is quantized according to a bark weight derived for the bark and channel, such quantizing creating one or more frequency ranges of such coefficients that are reduced to zero values (‘holes’) in one or more particular channels, the method for filling at least one hole with at least one non-zero value coefficient and comprising:
assigning, for a particular bark, each channel to one of one or more channel dependency groups (CDG), each CDG representing a grouping of channels based on a perceived similarity therebetween; and
for each CDG of the particular bark, examining every channel in the CDG for holes, and identifying a CDG hole requiring filling as a particular section of frequency bandwidth larger than a predetermined hole bandwidth threshold and with all zero-value coefficients in all channels after quantizing.

12. The medium of claim 11 wherein the method further comprises for each CDG of the particular bark:
recording, for each full length of the hole bandwidth threshold in the identified CDG hole, a maximum value of the coefficients of all channels prior to quantizing;
determining a minimum value of the recorded maximum values;
proportionally scaling the bark weight for each channel of the bark according to a common scalar so as to achieve a non-zero value for the coefficient having such minimum value; and
re-quantizing each channel according to the scaled bark weight thereof, whereby the coefficient having each recorded maximum value as re-quantized should have a non-zero value.

13. The medium of claim 12 wherein the scalar is calculated such that the encoder can produce a non-zero value for the coefficient having the minimum value.

14. The medium of claim 12 wherein the scalar is at least a quantization step size/2/the minimum value.

15. The medium of claim 11 wherein the CDGs change from bark to bark.

16. The medium of claim 11 wherein the method comprises identifying the CDG hole as a particular section of frequency bandwidth larger than a predetermined hole bandwidth threshold and with all zero-value coefficients in all channels after quantizing, where at least one coefficient of the CDG hole is non-zero prior to quantizing.

17. The medium of claim 11 wherein the hole bandwidth threshold is about 70 Hz.

18. The medium of claim 11 wherein the method comprises performing an algorithm with regard to each bark and each CDG thereof, the algorithm comprising:
```
for (i=0; i < number of barks; i++)
  for (j=0; j < number of CDG; j++)
    lastCodedCoeff = minimum position of lastCodedCoeff in all
    channels of CDG
    maxCodedCoeff = value of largest coefficient which is a hole (after
    lastCodedCoeff) in channel corresponding to lastCodedCoeff
    for (iCoeff=starting bark position; iCoeff < ending bark position;
    iCoeff++)
      if (coefficient is hole)
        update maxCodedCoeff with maximum of all values within
        CDG if any coefficients within CDG exceeds
        maxCodedCoeff
      if (at least one channel has non-zero coefficient)
        lastCodedCoeff = iCoeff;
        maxCodedCoeff = 0;
        mark current maxCodedCoeff as coefficient hole which
        needs to be coded (note maxCodedCoeff may be from
        previous bark)
        iCoeff = location of maxCodedCoeff (note this may put
        iCoeff back into previous bark);
        maxCodedCoeff = 0;
```

19. The medium of claim 11 wherein the method comprises performing an algorithm with regard to each bark and each CDG thereof, the algorithm as annotated comprising:
for (i=0; i<number of barks; i++)
For each sequential bark, from 0 Hz upward,
for (j=0; j<number of CDG; j++)
and for each CDG in the bark:
lastCodedCoeff = minimum position of lastCodedCoeff in all channels of
CDG
The ‘last coded coefficient’ is defined to be the minimum position of the last coded coefficient across all channels of the CDG.
maxCodedCoeff = value of largest coefficient which is a hole (after
lastCodedCoeff) in channel corresponding to lastCodedCoeff
The ‘maximum coded coefficient’ is defined to be the value of the largest coefficient prior to quantizing which is a hole after quantizing (i.e., initially quantized to a zero value) in the channel from which lastCodedCoeff was found.
for (iCoeff=starting bark position; iCoeff < ending bark position;
iCoeff++)
For each bark position within the bark, from the boundary with the previous bark and upward:
if (coefficient is hole)
If the coefficient at the bark position in each channel of the CDG is a hole,
update maxCodedCoeff with maximum of all values within
CDG if any coefficients within CDG exceeds
maxCodedCoeff
update maxCodedCoeff to be the maximum of all values of coefficients at the bark position within the CDG, but only if any of such values exceeds what was previously stored as maxCodedCoeff, and if updated note position and channel of maxCodedCoeff.
if (at least one channel has non-zero coefficient)
If the coefficient at the bark position in any channel of the CDG is not a hole (i.e., the ‘CDG hole’ has been found to end),
lastCodedCoeff=iCoeff;
update lastCodedCoeff to be the current bark position so as to note the beginning of a potential new CDG hole,
maxCodedCoeff=0;
and reset maxCodedCoeff to zero.
else if (distance from lastCodedCoeff>threshold)
However, if the coefficient at the bark position in any channel of the CDG is in fact a hole AND if the distance from lastCodedCoeff is greater than a threshold (i.e., a predetermined hole bandwidth threshold),
mark current maxCodedCoeff as coefficient hole which
needs to be coded (note maxCodedCoeff may be from
previous bark)
maxCodedCoeff is noted for coding,
iCoeff = location of maxCodedCoeff (note this may put
iCoeff back into previous bark);
iCoeff is noted as the bark position of the coefficient from which maxCodedCoeff was found,
maxCodedCoeff=0;
and reset maxCodedCoeff to zero.

20. The medium of claim 11 wherein the hole bandwidth threshold is modified based upon a target bit rate and frequency location.
